(19) United States
(12) Patent Application Publication
(10) Pub. No.: US 2007/0018041 A1
(43) Pub. Date: Jan. 25, 2007

(54) Model aircraft

(76) Inventors: Ernest Michael Butler, Mineral Wells, TX (US); Michael Douglas Connally, Weatherford, TX (US)

Correspondence Address: COHEN, PONTANI, LIEBERMAN & PAVANE, Suite 1210, 551 Fifth Avenue, New York, NY, 10176, US

(21) Appl. No.: 11/373,706

(22) Filed: Mar. 10, 2006

Related U.S. Application Data
(60) Provisional application No. 60/697,154, filed on Jul. 7, 2005.

(51) Int. Cl. B64C 35/00; B60V 3/00

(52) U.S. Cl. 244/105; 244/36; 180/116

(57) ABSTRACT

A toy vehicle adapted for remote control operation. The toy vehicle includes a pair of sponsons which are spaced apart by a horizontal wing. A tail section is provided. The tail section includes one or more moveable directional control surfaces. A motive mechanism is mounted directly or indirectly to the wing.

### RELATED APPLICATIONS

This application claims priority from U.S. Provisional Patent Application Ser. No. 60/697,154 which was filed on Jul. 7, 2005.

### BACKGROUND OF THE INVENTION

1. Field of the Invention

The present invention relates to the field of aeronautics and aircraft design, and provides a novel design particularly suited for model or toy aircraft.

2. Description of the Related Art

The present invention relates to the field of aeronautics and aircraft design, and provides a novel design particularly suited for model or toy aircraft.

Model aircraft have been known for many years, and generally are designed to resemble full sized aircraft. That is, model aircraft have generally consisted of an elongate fuselage, with a central wing extending laterally out from the fuselage, and a tail assembly at the aft end of the fuselage. The tail assembly will generally consist of a vertical tail on which a vertical rudder is mounted, and short horizontal tail wings extending from either the aft end of the fuselage, or the top end of the tail. The elevators, controlling climb and decent angles are mounted on the horizontal tail wings. Aileron, controlling pitch and roll are mounted on the central wings, and are used, with the rudder, too steer the aircraft by rolling it while turning.

Alternatively, as shown in commonly assigned U.S. Pat. No. 6,612,893, steering may be accomplished by controlling the relative rates of revolution of each of a pair of wing mounted engines.

It is known, moreover, to utilize electric motors to power the propellers or model aircraft, and this is shown in the aforementioned U.S. Pat. No. 6,612,893. Aircraft engines, for either full scale, or toy aircraft, may, depending on the overall design of the aircraft, be mounted in front of the main wing, on the wing, or behind the wing. In the former two configurations, the engine mount propellers known as tractor propellers, and in the later case, the propellers are known as pusher propellers. Propellers are generally mounted so as to be perpendicular to the longitudinal axis of the forward direction of flight. Lift is achieved by the flow of air over and under the wing surfaces. The wing surfaces are shaped so as to provide lift, by creating downwash and an area of low pressure above the wing, and an area of high pressure below the wing, as the wing is moving through the air. If the speed of the aircraft through the air decreases below a critical velocity, the aircraft will loose lift and stall when the air pressure difference above and below the wings falls below a critical level. Stall will also occur in traditional designs, if the angle of attack of the wing, relative to the direction of flight, increased beyond a critical point, usually about 15°.

It is known, furthermore, to utilize surfaces other than wing surfaces, to generate lift. This can be accomplished by blending the fuselage into the central wings, thereby creating an all wing design, such as is exemplified by the well known B-2 bomber of the US Air Force. Alternatively, a pair of pontoons or the like may be provided, with a flattened fuselage extending therebetween that can act like a wing. This design is shown in U.S. Pat. No. 5,273,238 (Sato), which teaches a twin-hull seaplane that also includes a traditional wing mounted above the fuselage. A wide flat fuselage and downwardly extending pontoons will assist in ground effect flight. Ground effect flight is flight that close to a ground or water surface, and uses the proximity of the surface to increase left by decreasing upward, and increasing the air pressure below the wing. In order to transition from surface effect aided flight to ordinary flight, a large amount of thrust or downwardly vectored thrust is generally required.

The basic form of a hydroplane racing boat is well known. Generically, such a boat consists of a tunnel hull to which are attached sponsons. The propulsive force is provided by a small submerged or semi-submerged propeller at the aft end of the tunnel hull centerbody. In high speed racing operation, the hull lifts up and hydroplanes on sponsons. When this happens the hydrodynamic drag is dramatically reduced and relatively high speeds over water are possible. In this mode, the horizontal tail and supporting vertical fins provide some inherent static stability, which passively makes the boat more stable at high speed. For directional control a submerged rudder is used. Occasionally, hydroplanes crash in spectacular accidents after lifting completely off the water and losing all control. Hydroplane racing boats are not designed for controlled flight in air.

For flight in air, two popular forms have emerged—the conventional aircraft configuration employing a wing with or without additional lifting surfaces, and the helicopter, generally and collectively called fixed-wing and rotary-wing aircraft. Although there are many flight vehicles that can be broadly classified as fixed-wing or rotary-wing aircraft as well as other categories too numerous to mention, none of them appear similar to the hydroplane racing boat in its basic form (FIG. 1).

For high-speed flight on water, wing-in-ground effect vehicles (WIGs) and WIG ships sometimes called ekranoplans have been studied. These vehicles depend on lift from a wing to ride out of the water at high speed and skim the water's surface on in effect sponsons or on a main centerline hull or fuselage. These concepts are not designed for operation on land nor for flight out-of-ground effect. Moreover, WIGs cannot fly stationary in a hover.

The hovercraft or air-cushion vehicle (ACV) rides on an air cushion supplied by a enclosed plenum chamber that requires continuous contact with a smooth surface. Hovercraft cannot fly nor hover.

None of the above vehicles look like a hydroplane racing boat with the ability to (1) skim the surface on land like a hovercraft, (2) hydroplane on water like a hydroplane racing boat, (3) take off and fly like a conventional fixed-wing craft and (4) stop in flight and hover like a helicopter. A vehicle capable of these modes of operation has been overlooked by prior innovators.

### SUMMARY OF THE INVENTION

The present invention provides a model aircraft that utilizes some aspects of traditional design, and some novel features to provide a vehicle that can maneuverable on water like a boat or hydroplane; that can be driven on land like a hovercraft, and which can be flown like a stunt plane.

The present invention solves the problem mentioned of above by providing a vehicle that can operated on land, on water, and in air, including hovering flight.

One form of the invention provides a vehicle that appears to look like a hydroplane racing boat with the main difference that instead of having one aft mounted propeller as is typical, there are two propellers mounted on the front edge of the tunnel hull. One attribute of this feature is that differential thrust by driving one propeller faster than another is used to turn the vehicle rather than using a rudder. Also, the diameter of each propeller nominally extends the width of the tunnel between the sponson and the centerbody housing the system electronics. This relatively large diameter is needed for efficient operation in air.

A second form of the invention is the thin foiled surface of the tunnel hull together with the outboard sponsons. A longitudinal cross-section of this foiled surface shows a concave to convex shaped airfoil, which is called a reflex airfoil. Such an airfoil is typically used on flying wing aircraft designs to provide for pitch stability. In this case, the tunnel center body is a flying wing made up of a thin foiled surface in the shape of a reflexed airfoil. The addition of the sponsons have the beneficial effect of increasing the effective aerodynamic span of the center flying wing when used in the current hydroplane configuration. The use of the thin airfoil on the vehicle is essential to have low aerodynamic drag for flight in air.

A third form of the invention is the moveable control surface at the aft end of the center flying wing. This control surface is used for pitch control of the vehicle. A variant of this design involves splitting the control surface at the center to provide independent control of the right and left sides. In this configuration, differential movement of the right and left control surfaces can provide for roll control of the vehicle. In addition, when the vehicle is pointed vertically up in hover flight, this type of control input is needed to counter the torque of the propellers when they rotate in the same direction.

A fourth form of the invention is to house the radio control electronics in the cockpit region of the tunnel hull. This location is needed to provide proper mass balance of the vehicle for flight operation in air. For a flying wing design, the center of gravity needs to be close to the 25% station along the airfoil of the wing.

A fifth form of the invention is the geometry of the centerbody and airscoop. The front part of the centerbody is streamlined in shape and only large enough to house part of the electronics. The aft part of the centerbody is bulky and adds considerable drag. Because this bulky region starting from the airscoop aft is located behind the 25% station of the wing, the high drag acting on this part of the centerbody provides for additional aerodynamic stability in pitch.

A sixth form of the invention is the oversized horizontal tail surface. It spans the width of the vehicle and has a chord length at least 20% of its span. This surface functions to produce additional static and dynamic stability in pitch for flight in air. An additional feature are the out-rigger sub-tail flying surfaces mounted on the ends of the sponsons. These surfaces further enhance the pitch stability of the vehicle for flight in air.

A seventh form of the invention relates to surface skimming on land. On the lower surface of the sponsons a harder material is used to avoid excessive abrasion when skimming along on hard surfaces, like concrete.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In photographs that illustrate the present invention by way of Example:

FIG. 1 is a perspective view of a first embodiment of the present invention;

FIG. 2 is a side view of the embodiments of FIG. 1;

FIG. 3 is a top view of the embodiments of FIG. 1;

FIG. 4 is a bottom view of the embodiments of FIG. 1;

FIG. 5 is a front view of the embodiments of FIG. 1;

FIG. 6 is a rear view of the embodiments of FIG. 1;

FIG. 7 is a detailed perspective view of the flight control surfaces at the aft end of the aircraft of FIG. 1;

FIG. 8 is a top view of a second embodiment of the present invention, without a motor;

FIG. 9 is a side view of the pontoon of the aircraft of FIG. 8;

FIG. 10 is a front view of the pontoon of the aircraft of FIG. 8;

FIG. 11 is a front perspective view of the pontoon of the aircraft of FIG. 8;

FIG. 12 is an underside view of the aircraft of FIG. 8;

FIG. 13 is a top view of the fore end of the aircraft of FIG. 8, showing engine placement and thrust angle;

FIG. 14 is a side view of the embodiment of FIG. 8, showing engine placement and thrust line;

FIG. 15 is a side perspective view of the embodiment of FIG. 8 showing thrust line and wing angle;

FIG. 16 is a diagram showing top, side and end views of a further embodiment of the present invention; and

FIG. 17 is a top perspective view of the present invention.

### DETAILED DESCRIPTION OF THE PRESENTLY PREFERRED EMBODIMENTS

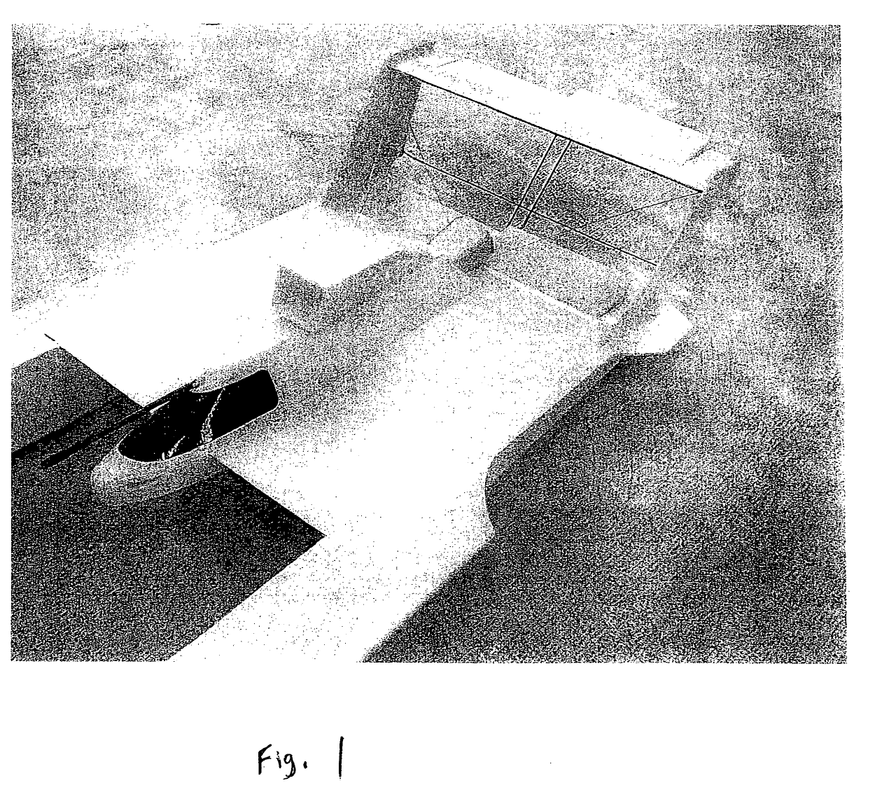

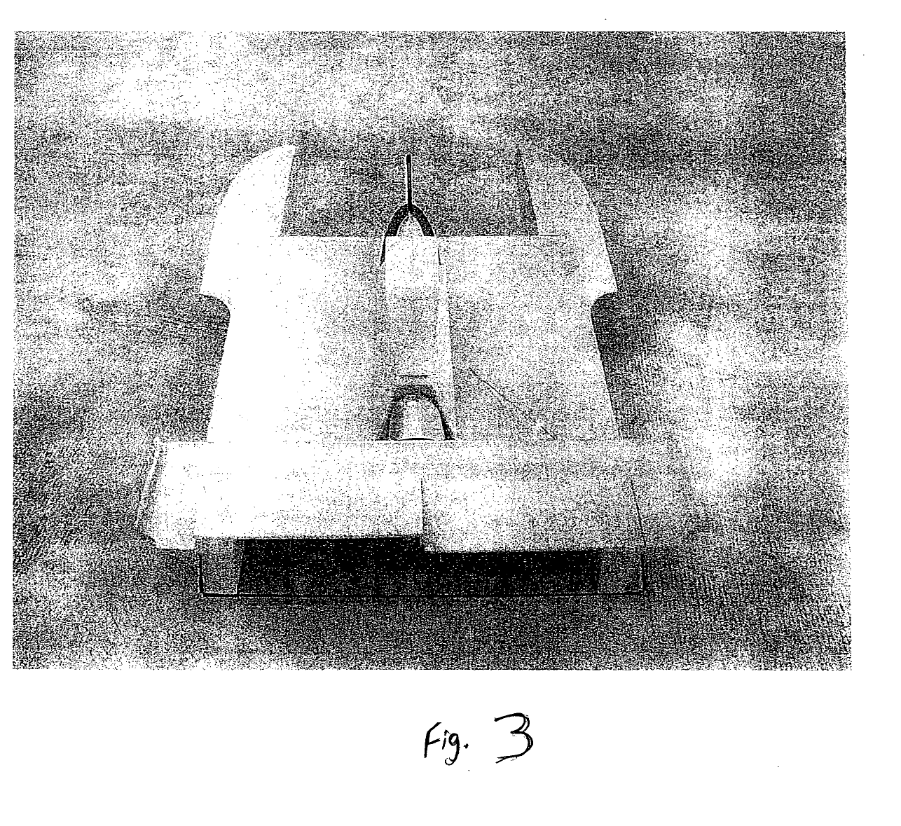

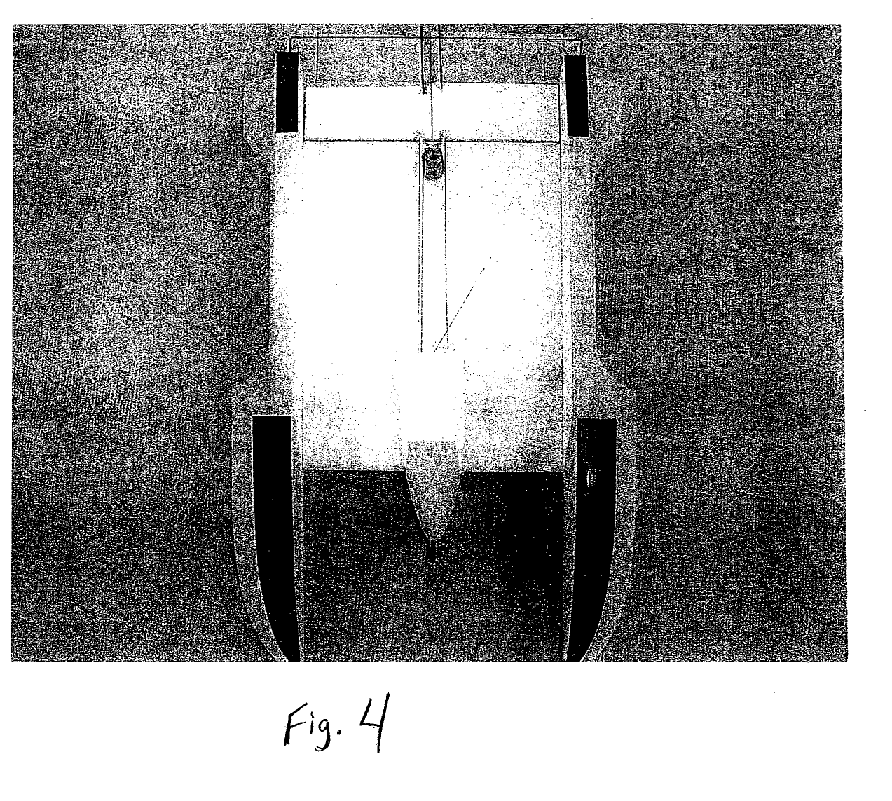

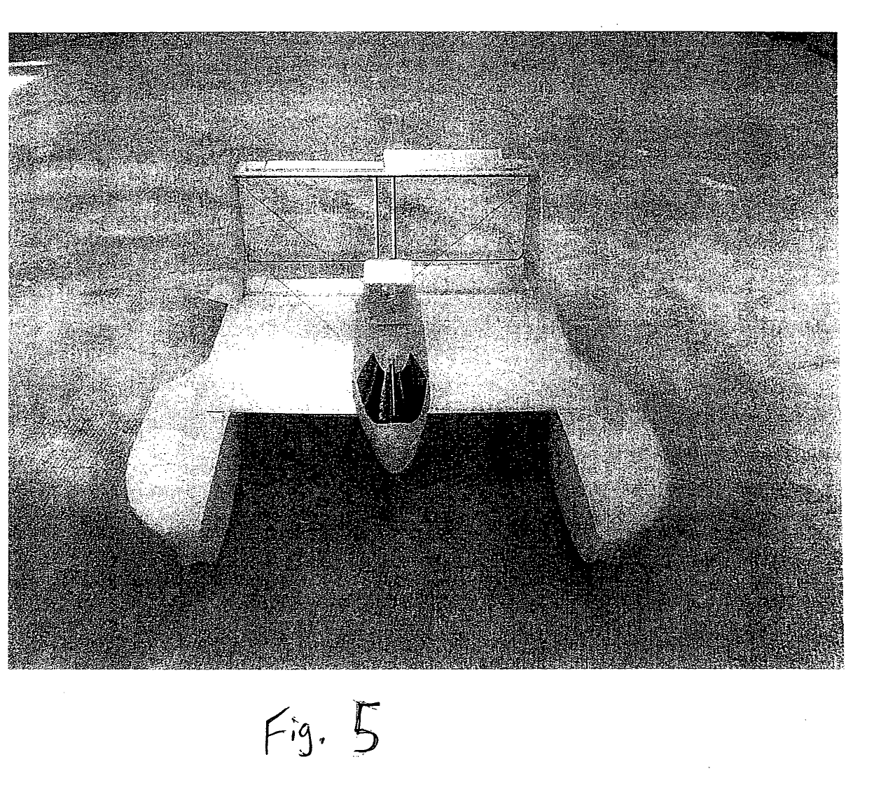

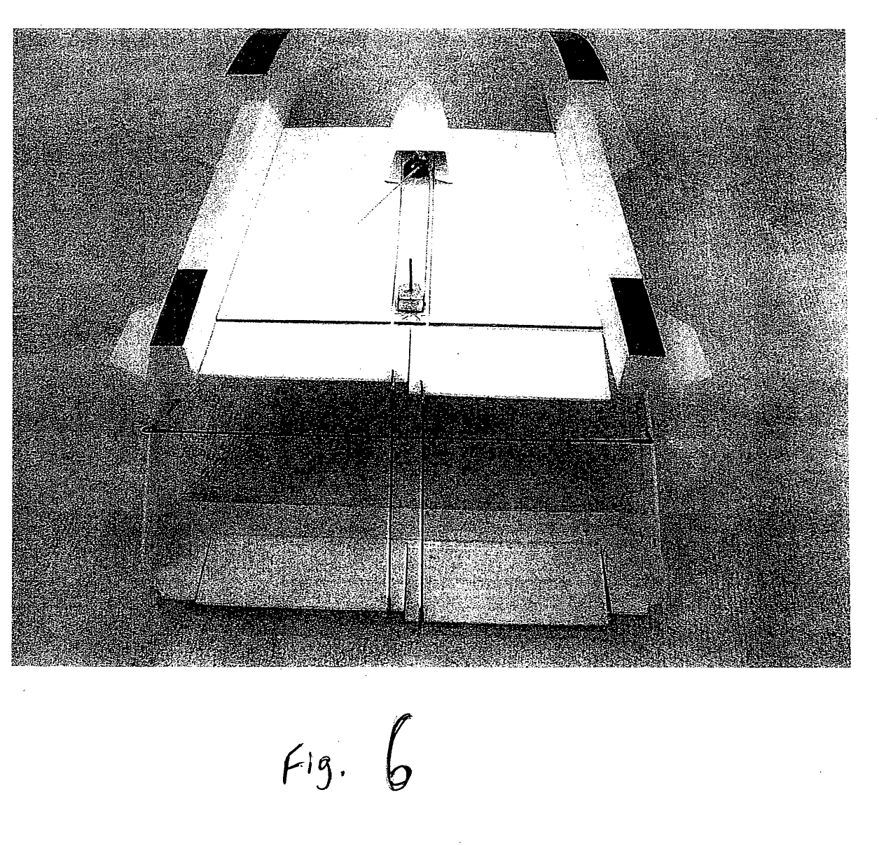

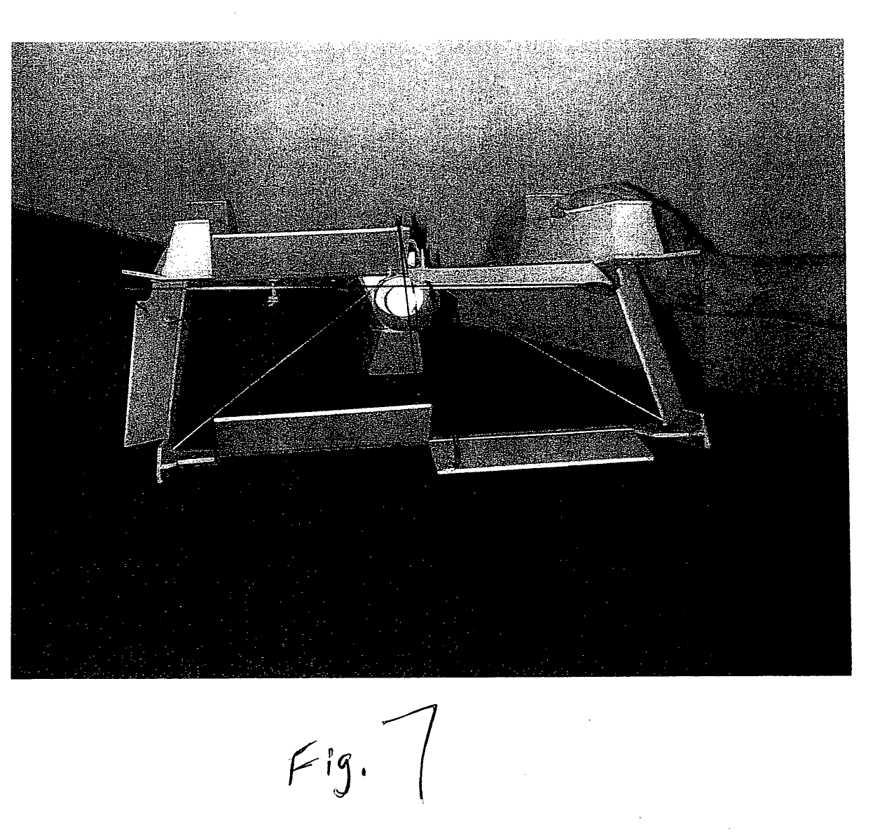

Referring now to FIGS. 1 to 7, the aircraft of the present invention includes a pair of pontoons (also referred to as floats or sponsons) that are separated by a substantially flat planar wing. A fuselage including a radio receiver, engine, propeller shaft housing and flight surface control motor or motors is centrally mounted on the planar wing.

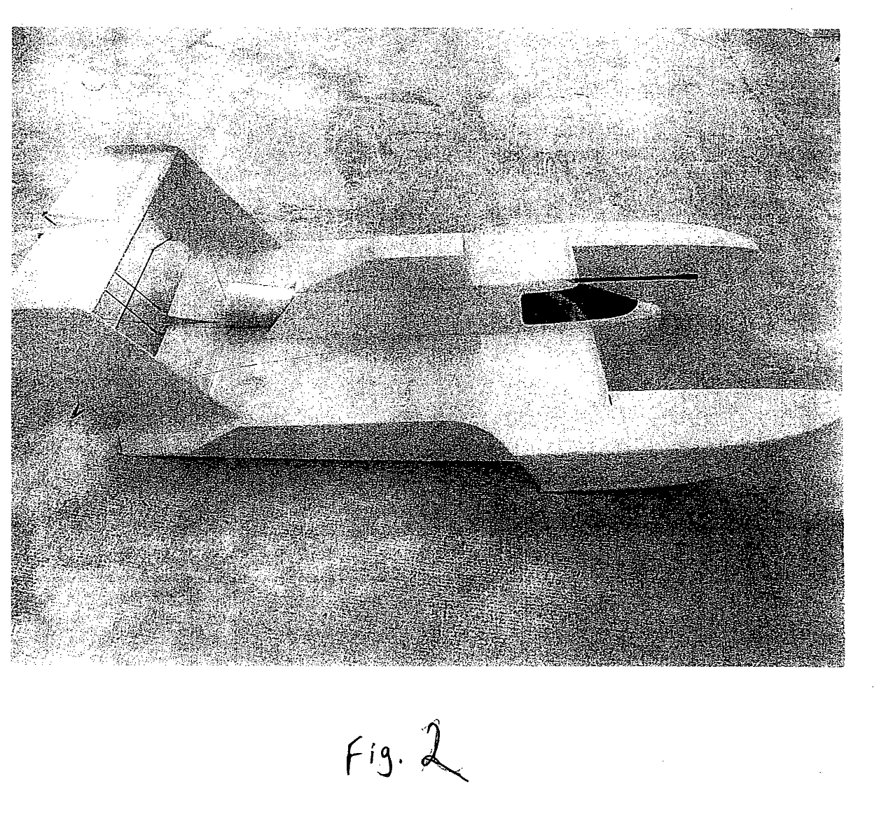

As can be seen clearly in FIG. 2, the forward ends of the pontoons are deeper than the aft ends, and moreover, each pontoon tapers from end to end. The pontoons have a flat lower surface the fore and aft portions of which are provided with a low friction, hardened, scuff and tear resistant coating. This can be made of fiberglass or a plastic or wood material. The remainder of the aircraft will be made from a very lightweight material, such as foamed polystyrene. Any lightweight sheet material capable of being formed and being resilient enough to maintain rigidity may be utilized as the principle material of the aircraft, however.

The lowermost surface of the pontoon includes a step about a third of the way from the front. This step, which is optional, improves performance on the water, as the aircraft will rise onto the forward portion of the pontoon and hydroplane, greatly reducing drag on the pontoon by the water, and thereby permitting a person to experience high-performance model boating from the aircraft of the present invention.

It will be observed, e.g. from FIG. 2, that the flat planar wing of the aircraft has a stationary angle of attack of about 5°-10°, preferably about 7°, which provides sufficient lift, without approaching the stall angle.

Each pontoon terminates in a vertical stabilizer which has a rudder. The two rudders are linked to move parallel to one another at all times.

The vertical stabilizers are spanned by a horizontal stabilizer having a split upper elevator build into it. A similar split lower elevator extends from the aft edge of the main planar wing. Each of the right and left halves of the upper and lower elevators is linked to one another. Accordingly, it will be understood that the elevators may be operated right and left halves together, in the manner of conventional elevators, to climb or dive; or the right and left elevators may be operated in the manner of ailerons, to control roll of the aircraft.

A hollow propeller shaft tube extends forwardly from the fuselage, and houses a tractor propeller shaft driven by a motor located in the fuselage. The motor may be electric or may be an internal combustion engine, but an electric motor is preferred for ease of use. A rechargeable battery is provided in the fuselage as well. The battery powers the motor, a radio receiver and control circuit, and motors such as conventional servo motors, that control the flight control surfaces at the aft end of the aircraft. Linkages between the servo motors and the flight control surfaces can be either solid rods, or flexible lines, and are substantially conventional.

The pontoons provide floatation, provide a surface to skim the water in hydroplaning mode, and function to keep the aircraft balanced during flight. The aircraft can also be driven on the ground. It uses ground-effect to reduce frictional drag so that it's propeller(s) can provide motion while it is in contact with the ground. Operating in ground effect also lifts the sponsons out of the water, reducing hydrodynamic drag. Operating the flight control surfaces allow the pilot to achieve high speeds while remaining in contact with the ground or water by increasing down forces, and preventing the nose from lifting. In the present invention, the controls can allow the pilot to deliberately lift the nose and cause the vehicle to transition from “boat” or “landspeeder” mode to flight mode. Once airborne, the controls stabilize the vehicle in forward flight, enable the pilot to make controlled turns, and to perform aerobatic maneuvers. An additional rudder (not shown), under the main wing, may also be provided to assist in steering on water.

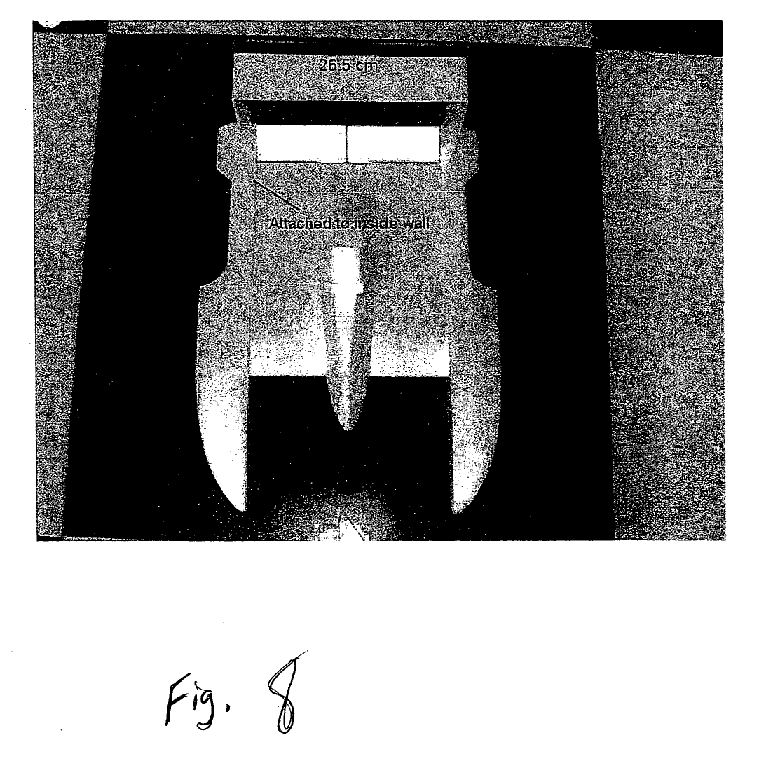

Referring to FIGS. 8 to 15, a two engine version of the aircraft of the present invention is shown. In the preferred embodiment of FIGS. 8-15, the operator provides control input to the wing control surface (called here the elevator control surface), total thrust, and differential thrust. Commands for total thrust and differential thrust are used by the onboard microprocessor to independently set the thrust of the two propellers. Commanding an increase in the total thrust increases the speed of both propellers equally for an increase in vehicle speed, while a differential thrust command increases the speed of one propeller more than the other for turning. Thus, to an operator, the commands are in effect thrust (total thrust), turning (differential thrust), and pitch (elevator).

It will be understood, moreover, that while single and double tractor propeller versions of the vehicle of the present invention have been described herein, it is also feasible to power the vehicle with one or two pusher propellers mounted at the rear of the vehicle, for instance on pylons or struts extending upwardly from the rear portion of the horizontal wing.

For surface skimming on land and water, the primary operator commands are thrust and turning. Elevator is then used to pitch the vehicle up, which at a sufficient speed will cause the vehicle to pitch up out of ground effect and fly like an airplane. Beyond this, additional pitch commands will cause the airplane to pitch up vertically into a hovering attitude that can be sustained as the operator gains skill coordinating all three primary controls.

Operation on land and water is successful owing to the beneficial ram air effects coupled with the lifting properties of the wing. To achieve this the design of the present invention provides an appropriate positive incidence angle on the wing relative to the ground. High thrust is necessary to lift up the tunnel hull and accelerate the vehicle, at which point less thrust is needed to sustain cruising speed since the vehicle has lifted off the ground slightly and reduced its own ground contact drag.

Directional stability is provided by the aft mounted vertical fins as well as the larger sponson surface drag area aft of the vehicle center of gravity. Directional control involves a complex interplay of aerodynamics, ground friction and vectored thrust. For a left turn command, the right propeller speed is increased by the onboard microprocessor. Higher thrust on the right side, yaws the vehicle to the left. This alone is not sufficient to turn the vehicle effectively. The shape of the sponsons plays a key role. With the vehicle in a left yaw, the right sponson produces less drag from both the aerodynamics and ground contact drag as compared with the left sponson. Since the left sponson has high drag, the vehicle yaws an additional amount. The yaw from the propellers combined with the yaw produced by the sponsons, is enough to point the vehicle and hence the thrust in the direction of the turn. At this point, the effects of thrust-vectoring cause the vehicle to turn. An additional contribution is produced by the lifting force of the center wing. Since the right sponson is angled on the outboard side, the vehicle tends to roll left when in a left yaw. This left roll causes the lift vector to tilt in the direction of the desired turn, and consequently the lift vector produces a force component in the direction of the turn.

For flight in air, stability and control in roll, pitch and yaw must be established (vs only yaw when in ground effect). Like many aircraft, the vehicle will have a slow spiral divergence which can be adequately controlled by the operator. In pitch, the vehicle has a positive static margin by way of using a reflexed airfoil augmented with the additional horizontal tail surfaces and appropriate placement of the center of gravity. Yaw stability is achieved by the aft mounted vertical fins and greater sponson side area aft of the center of gravity. Pitch control is achieved using the elevator control surface on the center flying wing. Turning input from the operator provides differential thrust, which yaws the airplane. The shape of the sponsons leads to roll coupling with yaw, and turns the airplane via the “dihedral effect”. In this case, when the vehicle is in a left yaw for a left turn, the right sponson projects a forward inclined surface to the oncoming airstream. This produces an upward force on the right side of the vehicle. The left sponson has a sharp lower edge (sharper than the top) and this causes a greater acceleration of the flow around the lower edge of the sponson, which leads to lower pressure and hence less lift on the left sponson. As in ground effect, the differential in the drag of the sponsons also causes an additional yaw contribution, and consequently a greater difference in lift between the right and left sponsons. This lift differential causes the vehicle to roll left, which tilts the lift vector and thereby turns the vehicle to the left as desired with left commanded input. The success of this maneuver obviously is quite depended on the shape of the sponsons—flat face on the side and beveled on the outside.

An additional consideration is pitch sensitivity in cruise flight. In cruise flight, the airscoop takes on an important function. It provides an area of high drag above the center of gravity. The resulting moment cancels the moment produced by the high drag on the sponsons which are below the center of gravity. The aft high-mounted horizontal tail also aids in balance the pitching moment in cruise flight.

To achieve hovering flight and a vertical climb depends first on having a high thrust-to-weight ratio. Successful and controllable hovering is achieve when the thrust-to-weight ratio is near two. Highly efficient micro-motors are provided as are high power batteries in a light-weight form, Moreover the entire structure of the vehicle is very light, which in the invention is achieved using advanced foam materials. A second favorable element for easily controllable hover is that the propeller thrust line be coincident with the center of gravity of the vehicle and the zero lift line of the airframe. This is achieved in the current invention.

The embodiment shown in FIGS. 8 to 15 also differs in that there is only one elevator located on the trailing edge of the main wing. The elevator may be split, as shown in FIG. 8, but this is not necessary. The horizontal stabilizer does not have any elevator and rudders are not necessarily provided. Power is also electric. This model has only one servo, but can be equipped with a second servo if rudder control is desired. This addition would allow the pilot to more easily roll the craft in the air.

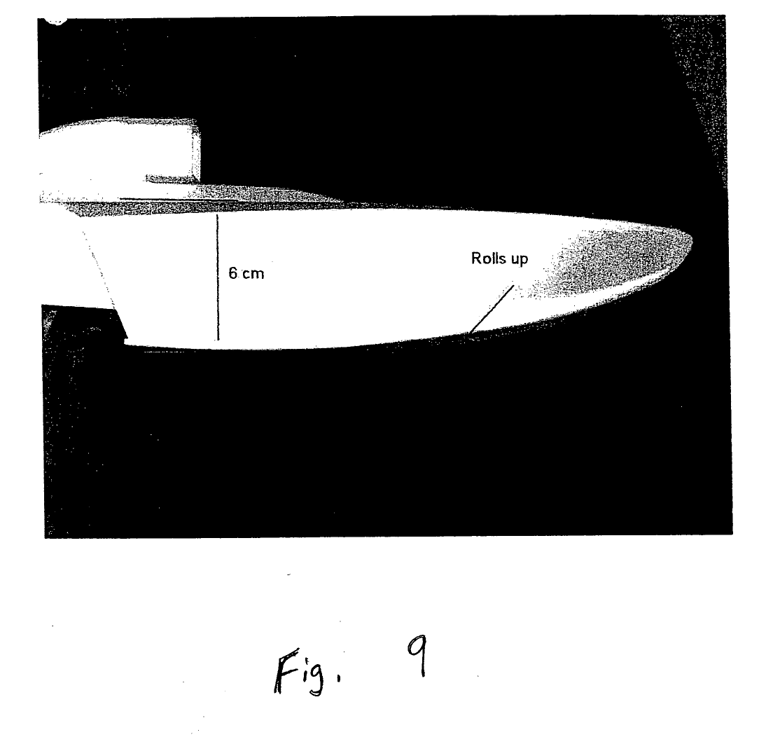

FIG. 9 shows the increase in step height and the upward curve of the bottom. **

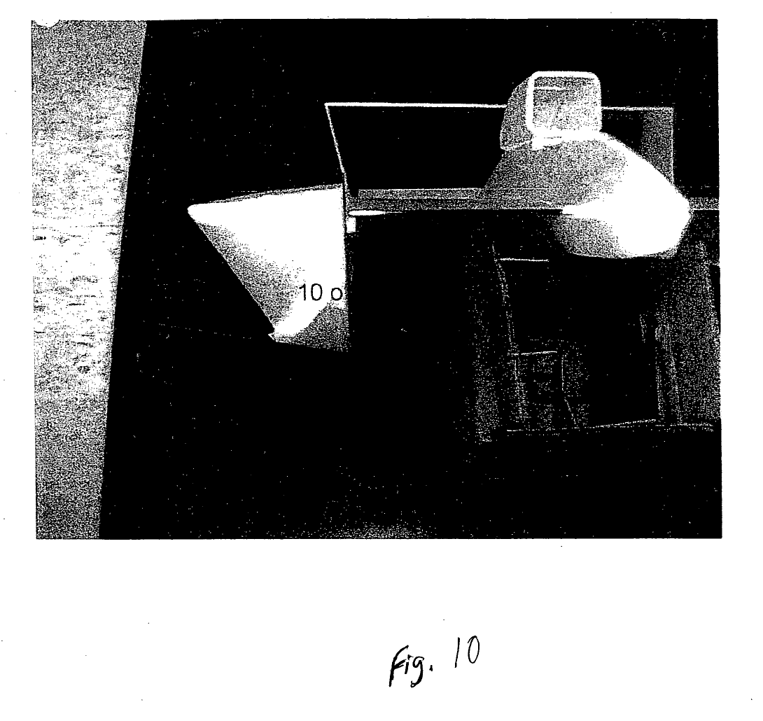

FIG. 10 shows the upward curve, this is to keep the front of the float from digging in at high speed on water during a turn.

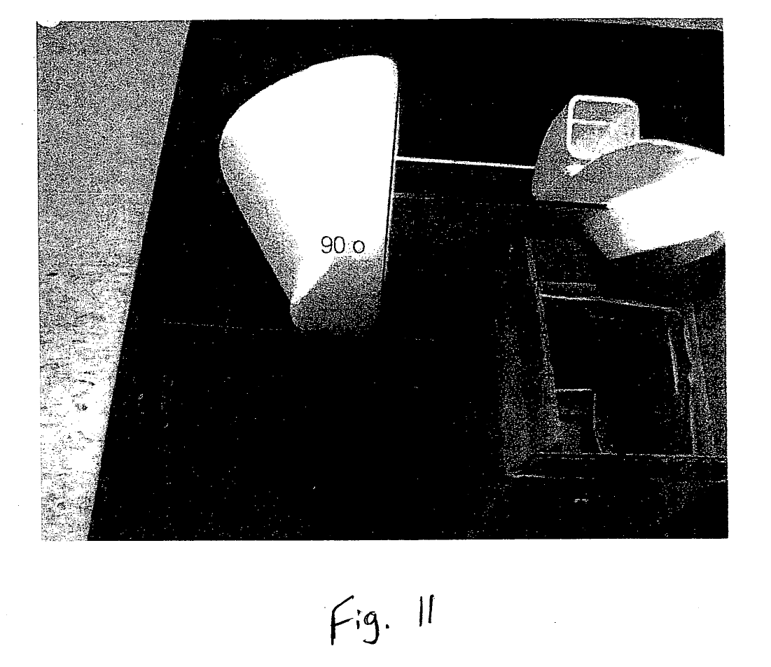

FIG. 11 shows that the area that the float sets o the ground is still flat.

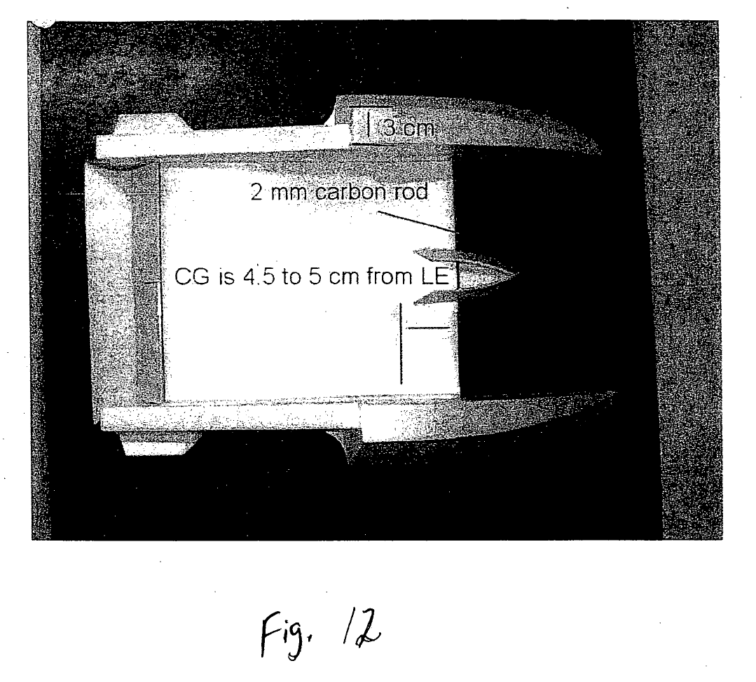

FIG. 12 shows the increase in step width, center of gravity location and a 2 mm rod for strength.

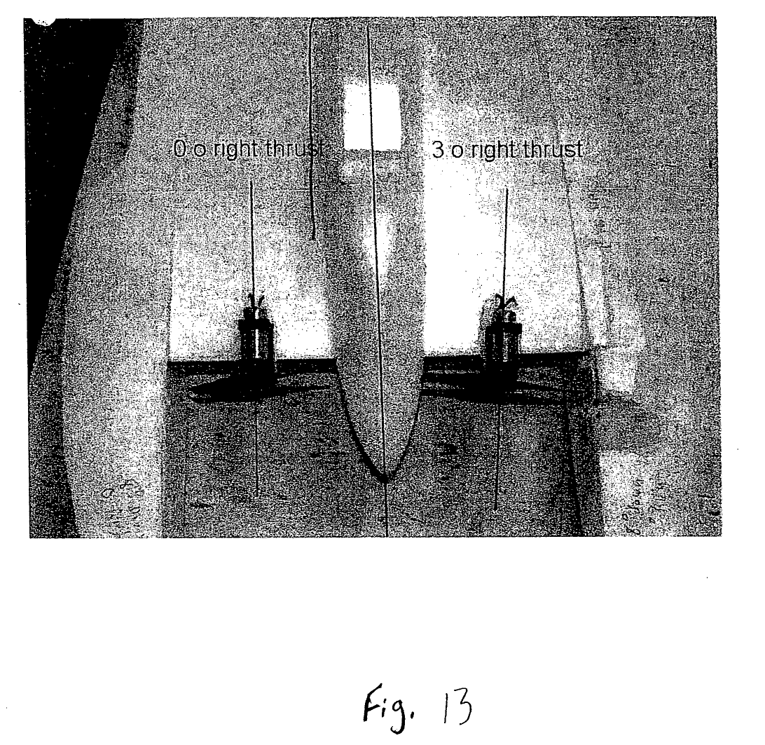

FIG. 13 illustrates a preferred thrust angle. With no right thrust, the aircraft tends to make a constant left turn and is difficult to turn right. With right thrust in both motors it will would turn right but will tuck or roll under in a left hand turn. With 0° in the right and 3° in the left, it flies and turns correctly.

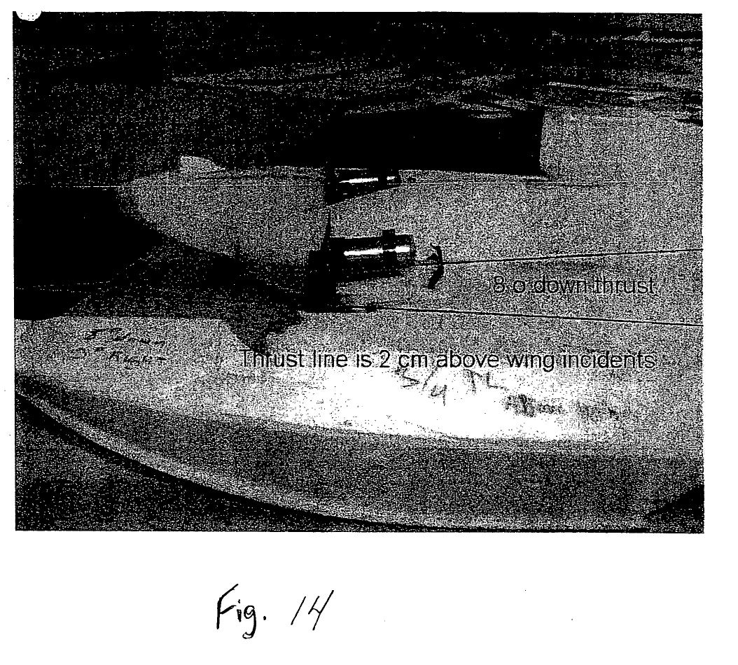

FIG. 14 shows thrust line. An upthrust tends to make the craft drop rapidly with low power and required a lot of elevator work to keep in the air. 8° down compared to wing incidents has been shown to be appropriate.

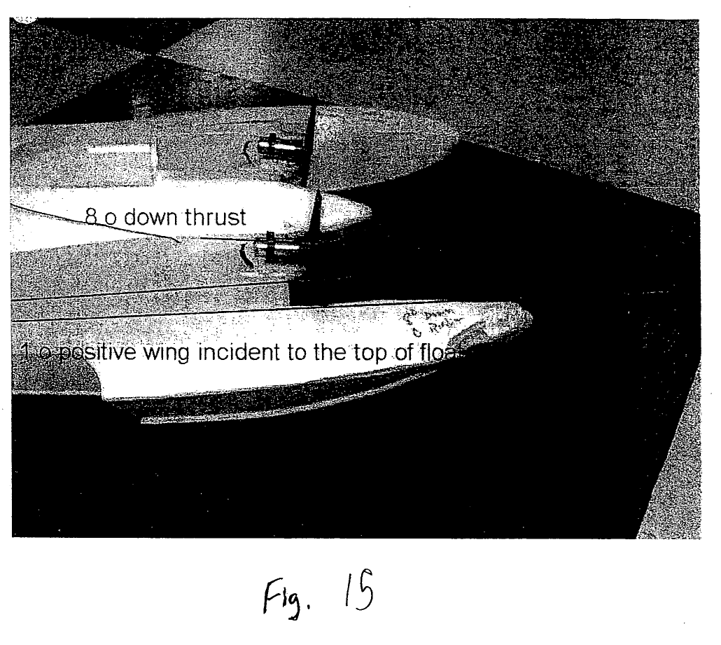

FIG. 15 shows a 1° positive wing incidents to the top of the float. This helps rotation.

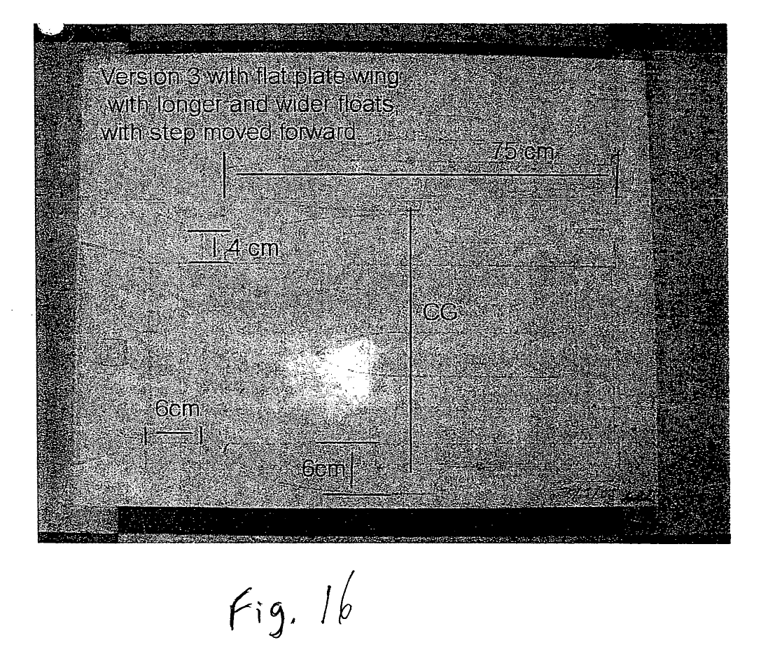

FIG. 16 is a drawing of a proposed design. A flat plate is proposed to help some of the pitching moment at higher speeds and should require less down-thrust. 4 cm wide floats to help get it on plane quicker without working the elevator to get it up. The floats are 2.5 cm longer with the step 2.5 cm farther forward to help in rotation on grass and water. The vertical dimensions will be taller with less angle and the horizontal dimensions will be much smaller.

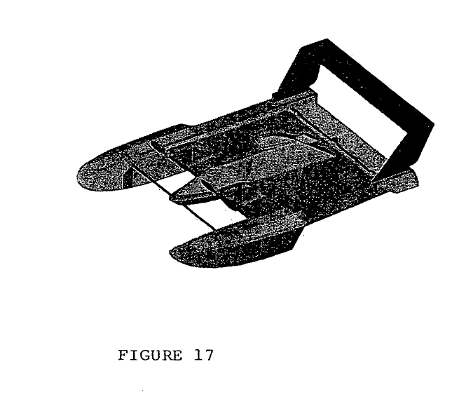

FIG. 17 is a top perspective of a further two-motor embodiment of the present invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A toy vehicle adapted for remote control operation comprising a pair of sponsons spaced apart by a horizontal wing, a tail section including one or more moveable directional control surfaces, and motive means mounted directly or indirectly to said wing.

2. A toy vehicle as claimed in claim 1, wherein each said sponson extends substantially from the front of the vehicle to the tail section, and has a substantially planar and vertical or near vertical inner face and an outer face that is inwardly inclined from top to bottom.

3. A toy vehicle as claimed in claim 2, wherein each said sponson has a flat upper surface and a flat lower surface, and said outer face extends between said upper and lower surfaces.

4. A toy vehicle as claimed in claim 3, wherein each said sponson has a front portion and a rear portion, the front portion being wider than the rear portion.

5. A toy vehicle as claimed in claim 4, wherein the outer surface of the front portion of each said sponson tapers inwardly from the rearward end thereof to the front end.

6. A toy vehicle as claimed in claim 5, wherein the taper of said front portion of each said sponson is convex.

7. A toy vehicle as claimed in claim 6, wherein toward the front end of each said sponson, the lowermost surface curves upwardly in a shallow convex curve.

8. A toy vehicle as claimed in claim 7, wherein said sponsons project forwardly of said horizontal wing.

9. A toy vehicle as claimed in claim 8, wherein said wing is a substantially horizontal planar web extending between said sponsons.

10. A toy vehicle as claimed in claim 9, wherein the rear portions of said sponsons are less deep than the front portions, whereby said wing is angled slightly upwardly from horizontal.

11. A toy vehicle as claimed in claim 10, wherein said tail section includes an upper tail surface and a lower tail surface, connected by a pair of vertical tail fins, one extending upwardly from the rearmost inner surface of each sponson.

12. A toy vehicle as claimed in claim 11, wherein at least one of said upper and lower tail surfaces is split into independently controllable right and left portions.

13. A toy vehicle as claimed in claim 12, wherein each of said upper and lower tail surfaces is split into independently controllable right and left portions, and each of said right portions is connected to the other.

14. A toy vehicle as claimed in claim 13, wherein said vertical tail fins are provided with hinged, rearwardly extending control surfaces.

15. A toy vehicle as claimed in claim 11, wherein said vehicle is provided with one or more motor driven propellers.

16. A toy vehicle as claimed in claim 15, wherein said one or more motor driven propellers are mounted at the front of said vehicle.

17. A toy vehicle as claimed in claim 16, wherein said one or more motor driven propellers are angulated slightly to provide down force.

18. A toy vehicle as claimed in claim 15, wherein said one or more motor driven propellers are mounted near the rear of said vehicle.

19. A toy vehicle as claimed in claim 16, wherein said vehicle includes a housing near the front edge of said wing, to house at least a radio receiver, a controller, and a power supply.

20. A toy vehicle as claimed in claim 19, wherein said power supply is a rechargeable battery, and said one or more motors are electric motors.

21. A toy vehicle as claimed in claim 20, wherein said vehicle is made from rigid, lightweight foam.
